(19) United States
(12) Patent Application Publication
(10) Pub. No.: US 2026/0131746 A1
(43) Pub. Date: May 14, 2026

(54) IN-VEHICLE CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Muneyoshi YABUTA, Yokkaichi-shi, Mie (JP); Ryota HIRATSUKA, Yokkaichi-shi, Mie (JP); Kazushi SHIMAMOTO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/110,301

(22) PCT Filed: Mar. 24, 2023
(86) PCT No.: PCT/JP2023/011700

§ 371 Date: Feb. 3, 2026

(51) Int. Cl. B60R 16/033; H01M 10/42; H01M 50/249; H02J 1/082; H02M 3/00; H02M 3/335

(52) U.S. Cl. CPC B60R 16/033; H01M 10/425; H01M 50/249; H02J 1/082; H02M 3/01; H02M 3/33571; H01M 2220/20

(57) ABSTRACT

An in-vehicle control includes a first relay provided between a high-voltage battery and a high-voltage load, a first voltage conversion unit between the first relay and a low-voltage load, a second voltage conversion unit in parallel with the first relay and the first voltage conversion unit and the control unit. The first voltage conversion unit converts a voltage input from the high-voltage battery via the first relay into a low-voltage and outputs the low-voltage to a low-voltage load side. The second voltage conversion unit converts a voltage input from the high-voltage battery into a low-voltage and outputs the low-voltage to the low-voltage load side. The control unit controls the first relay in an ON state, causing the first voltage conversion unit to perform the first conversion operation while the vehicle is traveling, causing the second voltage conversion unit to perform the second conversion operation while the vehicle is parked.

### CROSS-REFERENCE TO RELATED APPLICATIONS

This application is the U.S. national stage of PCT/JP2023/011700 filed on Mar. 24, 2023, the contents of which is incorporated herein.

### TECHNICAL FIELD

The present disclosure relates to an in-vehicle control device.

### BACKGROUND

JP 2017-159784A discloses a configuration in which power is supplied from a lithium ion battery to a lead battery, an electric load group, and the like via a step-up/down converter (voltage conversion unit).

The electric load group in JP 2017-159784A includes an electric load that operates in a parked state. The control device of JP 2017-159784A is configured to supply power from a lithium ion battery to a lead battery, and from the lead battery to the electric load that operates in the parked state, for example. In such a configuration, the lead battery is repeatedly charged/discharged even in the parked state, and deterioration of the lead battery is likely to progress. In addition, in the case of a configuration in which a system main relay (relay) is provided between the step up/down converter and the lithium ion battery, there is a concern that deterioration of the system main relay is likely to progress similarly to the lead battery.

The present disclosure has been made on the basis of the above-described circumstances, and an object thereof is to provide an in-vehicle control device capable of suppressing excessive progress of deterioration of at least a relay.

### SUMMARY

An in-vehicle control device of the present disclosure is an in-vehicle control device for use in an in-vehicle system including a high-voltage battery, a high voltage load, and a low-voltage load, the in-vehicle control device including: a relay provided between the high-voltage battery and the high-voltage load; a first voltage conversion unit provided between the relay and the low-voltage load; a second voltage conversion unit provided in parallel with the relay and the first voltage conversion unit; and a control unit configured to control the relay, the first voltage conversion unit, and the second voltage conversion unit, and the first voltage conversion unit performs a first conversion operation of converting a voltage input from the high-voltage battery side via the relay into a low-voltage lower than an output voltage from the high-voltage battery and outputting the low-voltage to the low-voltage load side, the second voltage conversion unit performs a second conversion operation of converting a voltage input from the high voltage battery side into the low-voltage and outputting the low-voltage to the low-voltage load side, and the control unit causes the first voltage conversion unit to perform the first conversion operation while controlling the relay to be in an ON state while a vehicle is traveling, and causes the second voltage conversion unit to perform the second conversion operation while the vehicle is parked.

### Advantageous Effects

With this configuration, it is possible to suppress excessive progress of the deterioration of a relay.

### BRIEF DESCRIPTION OF DRAWINGS

FIG. 1 is a block diagram illustrating an in-vehicle system provided with an in-vehicle control device according to a first embodiment.

FIG. 2 is a circuit diagram illustrating an example of the configuration of a first voltage conversion unit and a second voltage conversion unit according to the first embodiment.

FIG. 3 is a graph showing an example of power supply efficiencies with respect to output currents of the first voltage conversion unit and the second voltage conversion unit.

FIG. 4 is a flowchart showing an example of control of a control unit according to the first embodiment.

FIG. 5 is a block diagram illustrating an in-vehicle system provided with an in-vehicle control device according to a second embodiment.

FIG. 6 is a flowchart showing an example of control of a control unit according to the second embodiment.

### DETAILED DESCRIPTION OF PREFERRED EMBODIMENTS

Hereinafter, embodiments of the present disclosure will be listed and described.

In a first aspect, an in-vehicle control device is an in-vehicle control device for use in an in-vehicle system including a high-voltage battery, a high-voltage load, and a low-voltage load, the in-vehicle control device including: a relay provided between the high-voltage battery and the high-voltage load; a first voltage conversion unit provided between the relay and the low-voltage load; a second voltage conversion unit provided in parallel with the relay and the first voltage conversion unit; and a control unit configured to control the relay, the first voltage conversion unit, and the second voltage conversion unit, and the first voltage conversion unit performs a first conversion operation of converting a voltage input from the high-voltage battery side via the relay into a low-voltage lower than an output voltage from the high-voltage battery and outputting the low-voltage to the low-voltage load side, the second voltage conversion unit performs a second conversion operation of converting a voltage input from the high-voltage battery side into the low-voltage and outputting the low-voltage to the low-voltage load side, and the control unit causes the first voltage conversion unit to perform the first conversion operation while controlling the relay to be in an ON state while a vehicle is traveling, and causes the second voltage conversion unit to perform the second conversion operation while the vehicle is parked.

With the in-vehicle control device of the first aspect, by using the second voltage conversion unit in the parked state of the vehicle, use of the relay provided between the high-voltage battery and the high voltage load can be prevented. Accordingly, since the deterioration of the relay can be suppressed, the lifetime of the relay can be extended.

In a second aspect, the in-vehicle control device according to the first aspect, in which an output current when a power supply efficiency of the second voltage conversion unit is maximized is smaller than an output current when a power supply efficiency of the first voltage conversion unit is maximized.

It is envisaged that the power consumption of the low-voltage load is smaller while the vehicle is parked than that while the vehicle is traveling. Therefore, the in-vehicle control device of the second aspect is configured such that the output current when the power supply efficiency of the second voltage conversion unit is maximized is smaller than the output current when the power supply efficiency of the first voltage conversion unit is maximized, and thus it is easy to perform power supply suitable for the operation state of the low-voltage load in each of the traveling state and the parked state of the vehicle.

In a third aspect, the in-vehicle control device according to the second aspect, in which the first voltage conversion unit includes a first transformer configured to convert a voltage, the second voltage conversion unit includes a second transformer configured to convert a voltage, and an outer shape of the second transformer is smaller than an outer shape of the first transformer.

In the in-vehicle control device of the third aspect, since the output current when the power supply efficiency of the second voltage conversion unit is maximized is smaller than the output current when the power supply efficiency of the first voltage conversion unit is maximized, it is possible to make the second voltage conversion unit more compact than the first voltage conversion unit.

In a fourth aspect, the in-vehicle control device according to the first or the second aspect, in which the in-vehicle system includes a low-voltage battery, the low-voltage battery is capable of supplying power to the low-voltage load, and the control unit adjusts an output voltage of the second voltage conversion unit such that power supply from the second voltage conversion unit to the low-voltage load is prioritized over power supply from the low-voltage battery to the low-voltage load.

The in-vehicle control device of the fourth aspect can suppress the number of times of charging and discharging of the low-voltage battery, and can delay the deterioration of the low-voltage battery.

In a fifth aspect, the in-vehicle control device according to the first or the second aspect, in which the relay is a first relay, the in-vehicle control device further includes: a second relay provided between the high voltage battery and the second voltage conversion unit; and a battery case that houses the high-voltage battery, the control unit controls the second relay, the second relay and the second voltage conversion unit are provided in parallel to the first relay and the first voltage conversion unit, and the first relay and the second relay are provided inside the battery case.

With the in-vehicle control device of the fifth aspect, it is possible to reliably interrupt between the inside and the outside of the battery case with the first relay and the second relay, and it is easy to prevent the output voltage of the high voltage battery from being exposed to the outside of the battery case.

In a sixth aspect, the in-vehicle control device according to the first or the second aspect, in which a battery case that houses the high-voltage battery is further included, and the relay and the second voltage conversion unit are provided inside the battery case.

With the in-vehicle control device of the sixth aspect, by providing the high-voltage battery, the relay, and the second voltage conversion unit in the battery case, it is possible to construct a power supply unit that outputs two different voltages, namely, the output voltage output from the high voltage battery and the low voltage converted by the second voltage conversion unit.

### First Embodiment

The following describes a first embodiment that embodies the present disclosure.

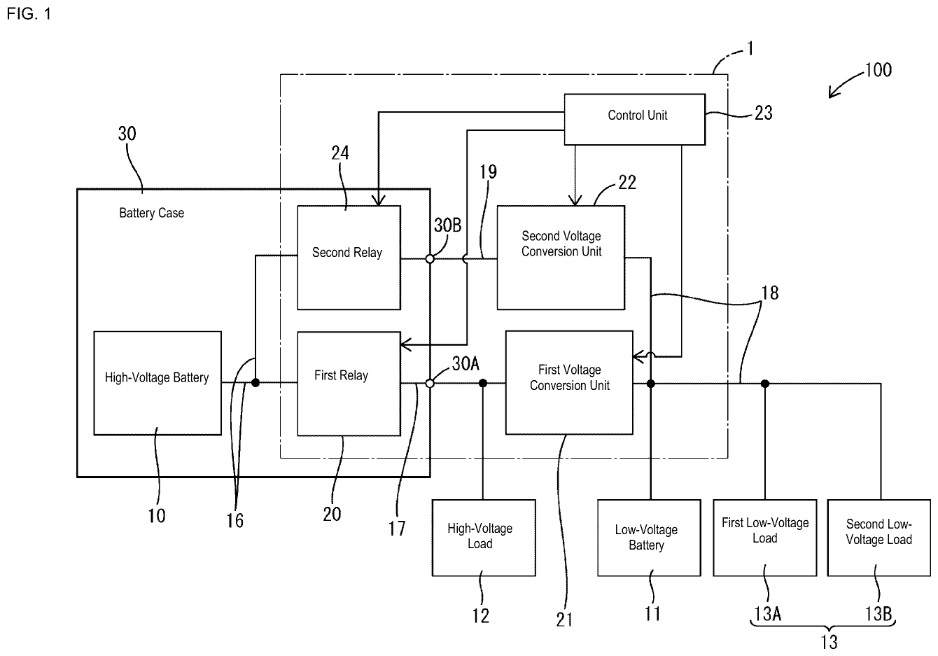

An in-vehicle system 100 shown in FIG. 1 is a power supply system to be mounted in a vehicle. The in-vehicle system 100 includes a high-voltage battery 10 for high voltage, a battery case 30 that houses the high voltage battery 10, a high-voltage load 12, a low-voltage battery 11, and a low-voltage load 13. The high-voltage load 12 operates using power supplied from the high voltage battery 10. The low-voltage battery 11 outputs a voltage lower than the output voltage of the high-voltage battery 10. The in-vehicle control device 1 of the present disclosure is used in the in-vehicle system 100. The in-vehicle control device 1 includes a first relay 20 that is a “relay”, a second relay 24 that is a “relay”, a first voltage conversion unit 21, a second voltage conversion unit 22, and a control unit 23.

### Configuration of In-Vehicle System

The high voltage battery 10 is, for example, a battery pack(?)/an assembled battery constituted by combining a plurality of single cells such as lithium-ion batteries or nickel-hydrogen batteries in series, and outputs a voltage of, for example, about 400V. The high-voltage battery 10 is housed in the battery case 30. The battery case 30 is configured to cover the entirety of the high-voltage battery 10. The battery case 30 is provided with a first terminal 30A and a second terminal 30B. A first conductive path 16 is electrically connected to a high-voltage-side terminal of the high voltage battery 10.

In the present disclosure, it is desirable that “electrically connected” is a configuration in which both connection targets are connected in a conductive state (a state in which a current can flow) so that the potentials of both connection targets are equal to each other. However, the present disclosure is not limited to this configuration. For example, “electrically connected” may be a configuration in which both connection targets are connected in a conductive state while an electrical component is interposed between both connection targets.

An output voltage of the high voltage battery 10 is directly applied to the high-voltage load 12 via a first relay 20 (described later). The high-voltage load 12 corresponds to, for example, a motor that drives wheels of a vehicle. Therefore, the high-voltage load 12 is a load that operates while the vehicle is traveling. Here, the concept of the vehicle traveling also includes a state in which the vehicle temporarily stops while traveling. The high-voltage load 12 is electrically connected to the first relay 20 via a second conductive path 17.

As the low-voltage battery 11, for example, a lead acid battery or a configuration in which cells of the same type as the high voltage battery 10 are used and the number of cells to be combined in series is reduced as compared with the high voltage battery 10 can be used. The low-voltage battery 11 is capable of outputting a voltage of about a 12V, for example. The low-voltage battery 11 is configured separately from the high voltage battery 10. The low-voltage battery 11 is electrically connected to a first voltage conversion unit 21 (described later) via a third conductive path 18.

The low-voltage load 13 includes a first low-voltage load 13A and a second low-voltage load 13B. The first low-voltage load 13A is, for example, a load that operates only while the vehicle is traveling. The first low-voltage load 13A corresponds to, for example, a sensor or the like that operates during travel to perform driving assistance when the vehicle is traveling. The second low-voltage load 13B is a load that operates not only while the vehicle is traveling but also while the vehicle is parked. The second low-voltage load 13B corresponds to, for example, a compressor of an air conditioner, a display disposed on a dashboard, an interior light, or the like. The low-voltage load 13 is electrically connected to the third conductive path 18. The low-voltage load 13 can be supplied with power from the low-voltage battery 11. The low-voltage load 13 can be supplied with power from the high voltage battery 10 via the first relay 20 (described later) and the first voltage conversion unit 21.

### Configuration of In-vehicle Control Device

The first relay 20 is a so-called System Main Relay (SMR). The operation of the first relay 20 is controlled by a control unit 23 (described later). The first relay 20 is switched between an ON state and an OFF state by the control unit 23. When the first relay 20 is in the ON state, the first conductive path 16 and the second conductive path 17 are electrically connected to each other via the first relay 20. As a result, the voltage of the high-voltage battery 10 applied via the first conductive path 16 is directly applied to the second conductive path 17. When the first relay 20 is in the OFF state, the first conductive path 16 and the second conductive path 17 are disconnected from each other. At this time, the voltage of the high-voltage battery 10 applied via the first conductive path 16 is not applied to the second conductive path 17. The first relay 20 is provided inside the battery case 30. The high-voltage load 12 is electrically connected to the second conductive path 17.

The second relay 24 is a so-called System Sub Relay (SSR). The operation of the second relay 24 is controlled by the control unit 23. The second relay 24 is switched between the ON state and the OFF state by the control unit 23. When the second relay 24 is in the ON state, the first conductive path 16 and the fourth conductive path 19 are electrically connected to each other via the second relay 24. As a result, the voltage of the high voltage battery 10 applied via the first conductive path 16 is directly applied to the fourth conductive path 19. When the second relay 24 is in the OFF state, the first conductive path 16 and the fourth conductive path 19 are disconnected. Accordingly, the voltage of the high-voltage battery 10 applied via the first conductive path 16 is not applied to the fourth conductive path 19. The second relay 24 is provided inside the battery case 30.

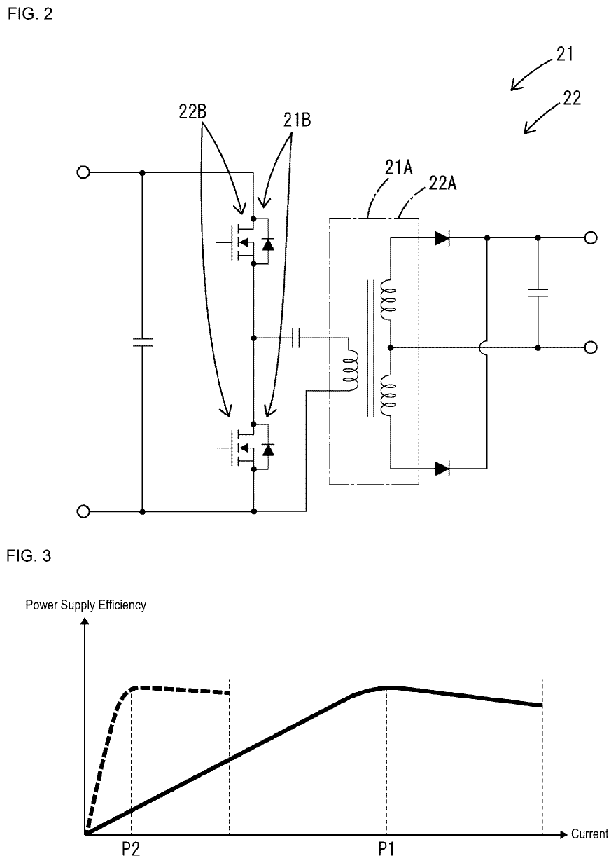

As shown in FIG. 2, the first voltage conversion unit 21 is a known insulated step-down DC-DC converter that includes a first transformer 21A having a voltage conversion function and is capable of stepping down a voltage. The first voltage conversion unit 21 has a configuration in which two switching elements 21B are connected in a half-bridge manner. A semi-conductor switch such as a MOSFET is used as the switching element 21B. The first voltage conversion unit 21 is a so-called LLC resonant DC-DC converter.

The first voltage conversion unit 21 performs a step-down operation of converting the voltage of the high voltage battery 10 applied to the second conductive path 17 into a low-voltage lower than the output voltage of the high-voltage battery 10 and applying the low-voltage to the third conductive path 18. The first voltage conversion unit 21 and the first relay 20 are electrically connected in series. The first voltage conversion unit 21 is provided outside the battery case 30. Therefore, the second conductive path 17 is configured to be drawn out from the battery case 30 to the outside of the battery case 30. The first terminal 30A of the battery case 30 is provided on the second conductive path 17. That is, the first relay 20 is provided between the first terminal 30A and the high-voltage battery 10.

The voltage applied from the first voltage conversion unit 21 to the third conductive path 18 is a voltage slightly higher than the charging voltage of the low-voltage battery 11 when fully charged. In this configuration, the step-down operation performed by the first voltage conversion unit 21 (the operation of converting the voltage input from the high-voltage battery 10 side via the first relay 20 into a low voltage lower than the output voltage of the high-voltage battery 10 and applying the low voltage to the low-voltage load 13 side) corresponds to an example of a first conversion operation. The first relay 20 is provided between the high voltage battery 10 and the high-voltage load 12.

The second voltage conversion unit 22 has a configuration similar to that of the first voltage conversion unit 21. As shown in FIG. 2, the second voltage conversion unit 22 is a known insulated step-down DC-DC converter that includes a second transformer 22A having a voltage conversion function and is capable of stepping down a voltage. The outer shape of the second transformer 22A is smaller than that of the first transformer 21A. The second voltage conversion unit 22 has a configuration in which two switch elements 22B are connected in a half-bridge configuration. A semi-conductor switch such as a MOSFET or the like is used as the switch elements 22B. The second voltage conversion unit 22 is a so-called LLC resonant DC-DC converter.

The second voltage conversion unit 22 performs a step-down operation of converting the voltage of the high voltage battery 10 applied to the fourth conductive path 19 into a low-voltage lower than the output voltage of the high voltage battery 10 and applying the low-voltage to the third conductive path 18. The second voltage conversion unit 22 and the second relay 24 are electrically connected to each other in series. The second voltage conversion unit 22 is provided outside of the battery case 30. Therefore, the fourth conductive path 19 is drawn out from the battery case 30 to the outside of the battery case 30. The second terminal 30B of the battery case 30 is provided on the fourth conductive path 19. That is, the second relay 24 is provided between the second terminal 30B and the high-voltage battery 10. The second relay 24 and the second voltage conversion unit 22 are provided in parallel with the first relay 20 and the first voltage conversion unit 21.

The control unit 23 adjusts the output voltage of the second voltage conversion unit 22 so that the power supply from the second voltage conversion unit 22 to the low-voltage load 13 is prioritized over the power supply from the low-voltage battery 11 to the low-voltage load 13. Specifically, the control unit 23 causes the output voltage of the second voltage conversion unit 22 to be applied to the third conductive path 18 at a voltage slightly higher than the charging voltage of the low voltage battery 11 when fully charged. In this configuration, the step-down operation performed by the second voltage conversion unit 22 (operation of converting the voltage input from the high-voltage battery 10 side into a low-voltage lower than the output voltage of the high voltage battery 10 and applying the low-voltage to the low-voltage load 13 side) corresponds to an example of a second conversion operation. The second relay 24 is provided between the high-voltage battery 10 and the second voltage conversion unit 22. When the first relay 20 and the second relay 24 are in the OFF state, the voltage of the high-voltage battery 10 is not applied to the second conductive path 17 and the fourth conductive path 19. Therefore, by turning off the first relay 20 and the second relay 24, it is possible to prevent the voltage of the high voltage battery 10 from being exposed to the outside of the battery case 30.

As shown in FIG. 3, the output current P2 when the power supply efficiency of the second voltage conversion unit 22 (the graph of the dotted line in FIG. 3) is maximized is set to be smaller than the output current P1 when the power supply efficiency of the first voltage conversion unit 21 (the graph of the solid line in FIG. 3) is maximized. Here, the power supply efficiency is a ratio of the power received by the load to the power output from the voltage conversion unit. That is, the second voltage conversion unit 22 can efficiently supply power to a load with small power consumption compared to the first voltage conversion unit 21. On the other hand, the first voltage conversion unit 21 can efficiently supply power to a load with large power consumption, compared to the second voltage conversion unit 22.

The control unit 23 is configured as, for example, a microcomputer, and includes a CPU, a ROM, a RAM, a nonvolatile memory, and the like. The control unit 23 is configured to receive, for example, a signal indicating that the vehicle is traveling (a signal indicating that a start switch is ON) or a signal indicating that the vehicle is parked (a signal indicating that the start switch is OFF) from an external ECU (not shown). Further, the control unit 23 is configured to receive, from the external ECU, a signal requesting power supply to the second low-voltage load 13B. The control unit 23 has a function of operating one of the first voltage conversion unit 21 and the second voltage conversion unit 22 based on this signal. The control unit 23 can perform control of individually switching each of the first relay 20 and the second relay 24 between the ON state and the OFF state based on a signal indicating that the vehicle is traveling (a signal indicating that the start switch is ON) or a signal indicating that the vehicle is parked (a signal indicating that the start switch is OFF).

The control unit 23 is configured to acquire a voltage value and a current value of each unit cell of the high-voltage battery 10, and detect a State of Charge (SOC) of the high-voltage battery 10 based on these values. As a method of detecting the SOC of the high voltage battery 10 by the control unit 23, various known methods can be adopted.

For example, when a signal indicating that the vehicle is traveling (a signal indicating that the start switch is ON) is input from the external ECU, the control unit 23 causes the first voltage conversion unit 21 to perform the first conversion operation while controlling the first relay 20 to be in the ON state. At this time, the control unit 23 controls the second relay 24 to be in the OFF state and does not cause the second voltage conversion unit 22 to perform the second conversion operation.

For example, when a signal indicating that the vehicle is parked (a signal indicating that the start switch is in the OFF state) is input from the external ECU, the control unit 23 causes the second voltage conversion unit 22 to perform the second conversion operation while controlling the second relay 24 to be in the ON state. At this time, the control unit 23 controls the first relay 20 to be in the OFF state and does not cause the first voltage conversion unit 21 to perform the first conversion operation. In this way, the control unit 23 controls the operations of the first relay 20, the second relay 24, the first voltage conversion unit 21, and the second voltage conversion unit 22.

### Control by Control Unit

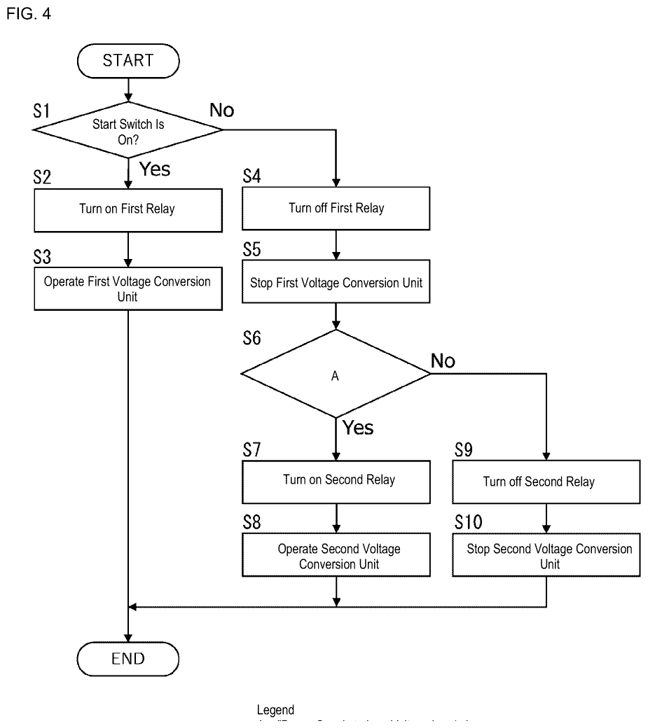

Next, an example of control executed by the control unit 23 will be described with reference to FIG. 4 and the like.

When a signal indicating that the start switch is in the ON state is input from the external ECU (YES in step S1), the processing proceeds to step S2, and the control unit 23 switches the first relay 20 to the ON state. The start switch is in the ON state corresponds to the instruction to switch the first relay 20 to the ON state. Accordingly, the voltage of the high voltage battery 10 is applied to the first voltage conversion unit 21. Then, the processing proceeds to step S3, and the control unit 23 operates the first voltage conversion unit 21. Accordingly, the first voltage conversion unit 21 applies a low-voltage to the low-voltage battery 11 and the low-voltage load 13. At this time, the control unit 23 switches the second relay 24 to the OFF state and does not operate the second voltage conversion unit 22. Then, the processing shown in FIG. 4 ends. In this manner, power is supplied to the high voltage load 12 and the low-voltage load 13 while the vehicle is traveling.

When a signal indicating that the start switch is in the OFF state is input from the external ECU (NO in step S1), the processing proceeds to step S4, and the control unit 23 switches the first relay 20 to the OFF state. Then, the processing proceeds to step S5, and the control unit 23 stops the operation of the first voltage conversion unit 21.

Next, when the processing proceeds to step S6, the control unit 23 determines whether or not power supply to the low-voltage load 13 via the second voltage conversion unit 22 is possible and necessary. Specifically, the control unit 23 determines whether or not a signal requesting power supply to the second low-voltage load 13B is being input from the external ECU. In step S6, when the control unit 23 determines that power supply to the low-voltage load 13 via the second voltage conversion unit 22 is possible and necessary (that is, a signal requesting power supply to the second low-voltage load 13B is being input from the external ECU) (YES in step S6), the processing proceeds to step S7, and the control unit 23 switches the second relay 24 to the ON state. Then, the processing proceeds to step S8, and the control unit 23 operates the second voltage conversion unit 22 and ends the processing shown in FIG. 4. In this manner, the second low-voltage load 13B is supplied with power and operates while the vehicle is parked.

In step S6, when the control unit 23 determines that power supply to the low-voltage load 13 via the second voltage conversion unit 22 is not possible or necessary (that is, a signal requesting power supply to the second low-voltage load 13B is not being input from the external ECU) (NO in step S6), the processing proceeds to step S9, and the control unit 23 switches the second relay 24 to the OFF state. Then, the processing proceeds to step S10, and the control unit 23 stops the operation of the second voltage conversion unit 22 and ends the processing shown in FIG. 4. At this time, since both the first relay 20 and the second relay 24 are turned off, the voltage of the high voltage battery 10 is not exposed to the outside of the battery case 30. The second low-voltage load 13B does not operate because it is not supplied with power. Since the voltage of the high-voltage battery 10 is not exposed to the outside of the battery case 30, the state “NO in step S6” is suitable for a case where maintenance is performed in the vehicle or a case where the detected SOC of the high-voltage battery 10 is in an unexpected state.

The following describes effects of the present configuration.

The in-vehicle control device 1 is used for the in-vehicle system 100 including the high-voltage battery 10, the high voltage load 12, and the low-voltage load 13. The in-vehicle control device 1 includes the first relay 20, the first voltage conversion unit 21, the second voltage conversion unit 22, and the control unit 23. The first relay 20 is provided between the high-voltage battery 10 and the high-voltage load 12. The first voltage conversion unit 21 is provided between the first relay 20 and the low-voltage load 13. The second voltage conversion unit 22 is provided in parallel with the first relay 20 and the first voltage conversion unit 21. The control unit 23 controls the first relay 20, the first voltage conversion unit 21, and the second voltage conversion unit 22. The first voltage conversion unit 21 performs a first conversion operation of converting a voltage input from the high-voltage battery 10 side via the first relay 20 into a low-voltage lower than the output voltage from the high-voltage battery 10 and outputting the low-voltage to the low-voltage load 13 side. The second voltage conversion unit 22 performs a second conversion operation of converting a voltage input from the high voltage battery 10 side into a low-voltage and outputting the low-voltage to the low-voltage load 13 side. The control unit 23 causes the first voltage conversion unit 21 to perform the first conversion operation while controlling the first relay 20 to be in the ON state while the vehicle is traveling, and causes the second voltage conversion unit 22 to perform the second conversion operation while the vehicle is parked.

According to this configuration, by using the second voltage conversion unit 22 while the vehicle is parked, it is possible to avoid using the first relay 20 provided between the high voltage battery 10 and the high-voltage load 12. Therefore, since the deterioration of the first relay 20 can be suppressed, the lifetime of the first relay 20 can be extended.

The output current P2 when the power supply efficiency of the second voltage conversion unit 22 is maximized is smaller than the output current P1 when the power supply efficiency of the first voltage conversion unit 21 is maximized. It is assumed that the power used by the low voltage load 13 is smaller when the vehicle is parked than when the vehicle is traveling. For this reason, the in-vehicle control device 1 is configured such that the output current P2 when the power supply efficiency of the second voltage conversion unit 22 is maximized is smaller than the output current P1 when the power supply efficiency of the first voltage conversion unit 21 is maximized, and thus it is easy to perform power supply suitable for the operation state of the low-voltage load 13 in each of the traveling state and the parked state of the vehicle.

The first voltage conversion unit 21 includes the first transformer 21A that converts a voltage, the second voltage conversion unit 22 includes the second transformer 22A that converts a voltage, and the outer shape of the second transformer 22A is smaller than the outer shape of the first transformer 21A. According to this configuration, since the output current P2 when the power supply efficiency of the second voltage conversion unit 22 is maximized is smaller than the output current P1 when the power supply efficiency of the first voltage conversion unit 21 is maximized, the second voltage conversion unit 22 can be made smaller than the first voltage conversion unit 21.

The in-vehicle system 100 includes the low-voltage battery 11. The low-voltage battery 11 can supply power to the low-voltage load 13, and the control unit 23 adjusts the output voltage of the second voltage conversion unit 22 so that the power supply from the second voltage conversion unit 22 to the low-voltage load 13 is prioritized over the power supply from the low-voltage battery 11 to the low-voltage load 13. With this configuration, the number of times of charging and discharging of the low-voltage battery 11 can be suppressed, and deterioration of the low-voltage battery 11 can be delayed.

The in-vehicle system 100 further includes the second relay 24 provided between the high-voltage battery 10 and the second voltage conversion unit 22 and the battery case 30 for housing the high-voltage battery 10, and the control unit 23 controls the second relay 24. The second relay 24 and the second voltage conversion unit 22 are provided in parallel with the first relay 20 and the first voltage conversion unit 21. The first relay 20 and the second relay 24 are provided inside the battery case 30. According to this configuration, the first relay 20 and the second relay 24 can reliably interrupt between the inside and the outside of the battery case 30, and making it easy to prevent the output voltage of the high-voltage battery 10 from being exposed to the outside of the battery case 30.

### Second Embodiment

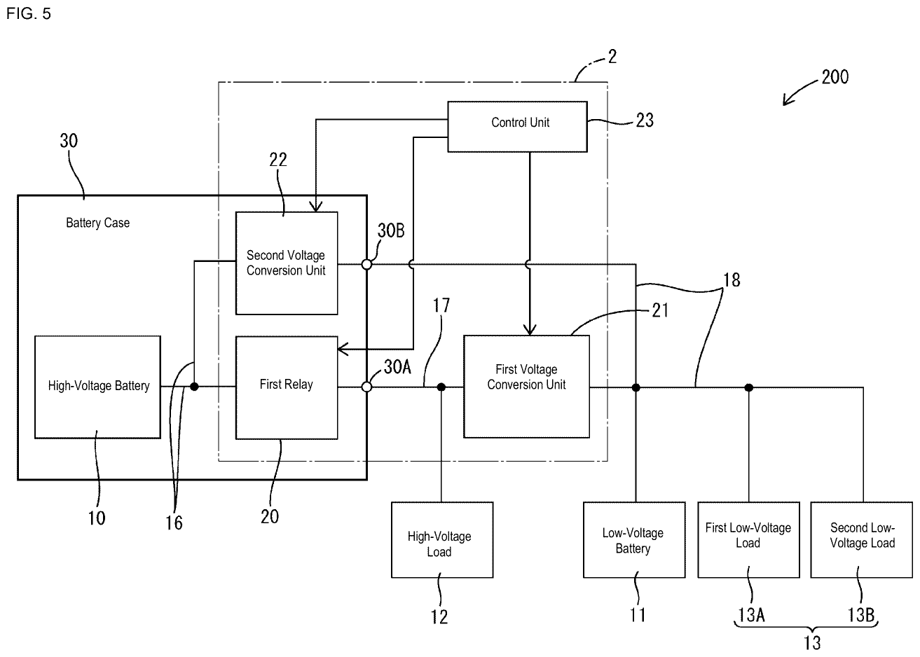

As shown in FIG. 5, an in-vehicle control device 2 of a second embodiment is different from that of the first embodiment in that a second relay is not provided, the second voltage conversion unit 22 is provided inside the battery case 30, and the like, and is the same as that of the first embodiment in other aspects. In the second embodiment, the same configurations as those of the first embodiment are denoted by the same reference numerals, and a detailed description thereof will be omitted. The in-vehicle system 200 is a power supply system to be mounted in a vehicle.

The first relay 20 is provided inside the battery case 30 together with the second voltage conversion unit 22. The first voltage conversion unit 21 is provided outside the battery case 30. The second voltage conversion unit 22 performs a step-down operation of converting the voltage of the high voltage battery 10 applied to the first conductive path 16 into a low-voltage lower than the output voltage of the high voltage battery 10 and applying a constant voltage to the third conductive path 18. The second voltage conversion unit 22 is housed in the battery case 30. Therefore, the third conductive path 18 electrically connected to the second voltage conversion unit 22 is drawn out from the battery case 30 to the outside of the battery case 30. The second terminal 30B of the battery case 30 is provided on the third conductive path 18. The second voltage conversion unit 22 is provided between the second terminal 30B and the high-voltage battery 10. The second voltage conversion unit 22 is provided in parallel with the first relay 20 and the first voltage conversion unit 21.

### Control by Control Unit

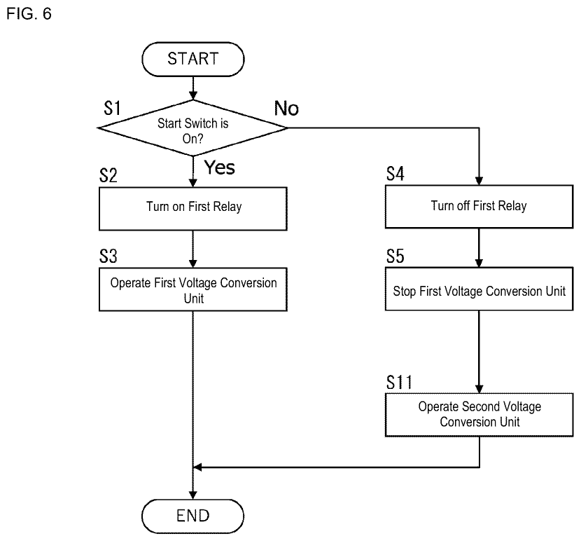

Next, an example of control performed by the control unit 23 will be described with reference to FIG. 6 and the like.

From steps S1 to S5, the same processing as in the first embodiment is executed. Specifically, when a signal indicating that the start switch is in the OFF state is input from the external ECU (NO in step S1), the processing proceeds to step S4. When the processing proceeds to step S4, the control unit 23 switches the first relay 20 to the OFF state, the processing proceeds to step S5, and the control unit 23 stops the operation of the first voltage conversion unit 21.

Then, when the processing proceeds to step S11, the control unit 23 operates the second voltage conversion unit 22. In this manner, the second low-voltage load 13B is supplied with power and operates while the vehicle is parked.

The battery case 30 that houses the high voltage battery 10 is provided, and the first relay 20 and the second voltage conversion unit 22 are provided inside the battery case 30. According to this configuration, by providing the high-voltage battery 10, the first relay 20, and the second voltage conversion unit 22 in the battery case 30, it is possible to form a power supply unit that outputs two different voltages, namely, the output voltage output from the high-voltage battery 10 and the low-voltage converted by the second voltage conversion unit 22.

### Other Embodiments

The embodiments disclosed here are to be considered in all respects as illustrative and not restrictive. The scope of the present disclosure is indicated by the claims rather than being limited to the foregoing examples, and all changes which come within the meaning and range of equivalency of the claims are intended to be embraced therein.

Unlike the first and second embodiments, the control unit may be housed in the battery box.

In the second voltage conversion unit, in addition to reducing the size of the outer shape of the second transformer, it is also possible to reduce the scale of a water-cooled configuration or an air-cooled configuration, reduce the width of a wiring pattern provided on a substrate, reduce the size of a heat dissipation sink, or reduce the size of a housing that houses the second voltage conversion unit.

Unlike the first and second embodiments, the first voltage conversion unit and the second voltage conversion unit may be connected in a full-bridge manner. Alternatively, a forward method or a flyback method may be adopted for the first voltage conversion unit and the second voltage conversion unit.

1. An in-vehicle control device for use in an in-vehicle system including a high-voltage battery, a high-voltage load, and a low-voltage load, the in-vehicle control device comprising:
a relay provided between the high-voltage battery and the high-voltage load;
a first voltage conversion unit provided between the relay and the low-voltage load;
a second voltage conversion unit provided in parallel with the relay and the first voltage conversion unit; and
a control unit configured to control the relay, the first voltage conversion unit, and the second voltage conversion unit,
wherein the first voltage conversion unit performs a first conversion operation of converting a voltage input from the high-voltage battery side via the relay into a low-voltage lower than an output voltage from the high-voltage battery and outputting the low-voltage to the low-voltage load side,
the second voltage conversion unit performs a second conversion operation of converting a voltage input from the high-voltage battery side into the low-voltage and outputting the low-voltage to the low-voltage load side, and
the control unit causes the first voltage conversion unit to perform the first conversion operation while controlling the relay to be in an ON state while a vehicle is traveling, and causes the second voltage conversion unit to perform the second conversion operation while the vehicle is parked.

2. The in-vehicle control device according to claim 1,
wherein an output current when a power supply efficiency of the second voltage conversion unit is maximized is smaller than an output current when a power supply efficiency of the first voltage conversion unit is maximized.

3. The in-vehicle control device according to claim 2, wherein
the first voltage conversion unit includes a first transformer configured to convert a voltage,
the second voltage conversion unit includes a second transformer configured to convert a voltage, and
an outer shape of the second transformer is smaller than an outer shape of the first transformer.

4. The in-vehicle control device according to claim 1, wherein
the in-vehicle system includes a low-voltage battery,
the low-voltage battery is capable of supplying power to the low-voltage load, and
the control unit adjusts an output voltage of the second voltage conversion unit such that power supply from the second voltage conversion unit to the low-voltage load is prioritized over power supply from the low-voltage battery to the low-voltage load.

5. The in-vehicle control device according to claim 1, wherein
the relay is a first relay,
the in-vehicle control device further comprises:
a second relay provided between the high-voltage battery and the second voltage conversion unit; and
a battery case that houses the high-voltage battery,
the control unit controls the second relay,
the second relay and the second voltage conversion unit are provided in parallel to the first relay and the first voltage conversion unit, and
the first relay and the second relay are provided inside the battery case.

6. The in-vehicle control device according to claim 1, further comprising a battery case that houses the high-voltage battery,
wherein the relay and the second voltage conversion unit are provided inside the battery case.

7. The in-vehicle control device according to claim 2, wherein
the in-vehicle system includes a low-voltage battery,
the low-voltage battery is capable of supplying power to the low-voltage load, and
the control unit adjusts an output voltage of the second voltage conversion unit such that power supply from the second voltage conversion unit to the low-voltage load is prioritized over power supply from the low-voltage battery to the low-voltage load.

8. The in-vehicle control device according to claim 2, wherein
the relay is a first relay,
the in-vehicle control device further comprises:
a second relay provided between the high-voltage battery and the second voltage conversion unit; and
a battery case that houses the high-voltage battery,
the control unit controls the second relay,
the second relay and the second voltage conversion unit are provided in parallel to the first relay and the first voltage conversion unit, and
the first relay and the second relay are provided inside the battery case.

9. The in-vehicle control device according to claim 2, further comprising a battery case that houses the high-voltage battery,
wherein the relay and the second voltage conversion unit are provided inside the battery case.
